(19) United States
(12) Patent Application Publication
(10) Pub. No.: US 2020/0150225 A1
(43) Pub. Date: May 14, 2020

(54) DETERMINING TRANSMISSION PHASE SHIFTS FOR A RADAR WITH A PLURALITY OF JUXTAPOSED TRANSMISSION PATHS

(71) Applicant: OFFICE NATIONAL D'ETUDES ET DE RECHERCHES AÉROSPATIALES, PALAISEAU (FR)

(72) Inventors: Mathieu CATTENOZ, MALAKOFF (FR); Philippe BROUARD, VANVES (FR)

(21) Appl. No.: 16/677,966

(22) Filed: Nov. 8, 2019

(30) Foreign Application Priority Data
Nov. 9, 2018 (FR) 18 60352

(51) Int. Cl. G01S 7/40; H04B 17/12

(52) U.S. Cl. CPC G01S 7/4008; G01S 7/4026; H04B 17/12

(57) ABSTRACT

A transmission phase shift (Φ₀₂, Φ₀₃) can be determined, as it exists between at least two transmission paths (10₁, 10₂, 10₃) of a radar. For this purpose, components of a radar return signal, in a one-to-one relation to the transmission radiations (R₁) which are separately produced by the two transmission paths, are identified by different modulations. It is then possible to compensate for each transmission phase shift in order to better control the transmission-reception direction of the radar as well as the beam shape. The development is applicable in particular to MIMO type radars.

### BACKGROUND OF THE INVENTION

### Field of the Invention

The present invention relates to a method for determining transmission phase shifts for a radar which has a plurality of juxtaposed transmission paths. It can be applied in many areas, including radar surveillance for detecting intrusions into a space to be secured, telecommunications, etc.

### Description of the Related Art

In a known manner, a phased array radar and/or beamforming radar comprises several transmission paths that feed radiating elements juxtaposed in an antenna array. Each transmission path comprises an input for receiving the signal to be transmitted, a variable phase shifter, an amplifier, and a radiating element which is fed with the signal to be transmitted after this signal has been phase-shifted and amplified. The direction of the radiation beam produced by the antenna array in order to transmit the signal, as well as the shape of this beam, meaning the radiation pattern of the radar, are adjusted by phase shift values which are applied individually to the transmission paths. However, unintentional phase shift contributions may also exist between different radar transmission paths, so that the phase shifts actually produced between these transmission paths do not exactly correspond to the desired phase shift values. This results in uncertainty in the direction and shape of the radiation beam produced by the radar.

In particular, multiple input—multiple output radars, designated by the acronym MIMO, are of this type and present this uncertainty in the phase shifts that exist between different transmission paths.

Generally speaking, in the present description, the phrase phase shift that exists between two transmission paths or between two signals is understood to mean a difference between two phase values which are in a one-to-one relation to the two transmission paths or to the two signals. By extension and equivalence, such a phase shift will also be understood to mean a time offset that exists between the operation of the two transmission paths or which exists between the two signals.

In a manner that is also known, modulations which are orthogonal are understood to mean modulations that enable separating, by filtering, components of a signal that each includes one of these modulations, different from the modulation of each other component of the signal. More precisely, the result of filtering in accordance with one of the modulations, when applied to signal components which are individually modulated, is non-zero for the component of the signal which has the modulation of the filter, and zero or substantially zero for each component of the signal which has a modulation orthogonal to that of the filter. In the following, the term “orthogonal modulations” will designate both the modulations that are strictly orthogonal and the modulations that are substantially orthogonal, in other words for which the result of the filtering can be considered as substantially zero or below a predetermined threshold.

In particular, MIMO type radars make it possible to apply modulations that are orthogonal to transmission paths that are different within each of these radars.

In general, the invention which is the subject of the present patent application can be combined with any known type of modulation, including modulations by code designated by the acronym CDMA for “code-division multiple access”, modulations by discrete frequencies designated by FDMA for “frequency-division multiple access”, time shift modulations designed by TDMA for “time-division multiple access”, and so on.

### SUMMARY OF THE INVENTION

In this context, one aim of the invention is to allow improved control of the radiation pattern of a radar with multiple transmission paths.

An additional aim of the invention is to allow such an improvement in beam control to be achieved without using specific test components, or without particular test conditions being required. In particular, it is desirable that the improvement in beam control that is produced by the radar can be achieved without the need for specific maintenance operations, only resulting from mission-related use of the radar.

Yet another object of the invention is to provide a diagnosis of a deterioration that a radar with multiple transmission paths can undergo over time, whether this involves ageing or a malfunction in some of its transmission components, possibly in order to command radar maintenance operations or actions to correct some of its operating parameters.

For this purpose, a first aspect of the invention proposes a method for determining at least one transmission phase shift of a radar which comprises at least two transmission paths that are juxtaposed and at least one reception path. The invention applies when the radar is arranged so that each of its transmission paths produces a transmission radiation modulated in accordance with a modulation that is assigned to this transmission path, and that is orthogonal to the modulation that is assigned to each of the other transmission paths. Another condition for the invention is that, when the radar reception path detects a return signal, this return signal is filtered in accordance with each modulation. In this manner, for each modulation, regardless of the transmission path for which it is used, a component of the return signal which has this modulation is isolated. Then, the method of the invention comprises the following steps:
/1/ activating the transmission paths to produce the modulated transmission radiations and activating the reception path to detect the return signal, then filtering this return signal in accordance with each modulation;
/2/ separately for each modulation: determining a value of a phase shift between transmission and reception, called the transmission-reception phase shift for this modulation, which exists between the transmission radiation produced and modulated in accordance with the modulation and the component of the return signal which has been isolated in accordance with the same modulation, this transmission-reception phase shift being determined for signal passage points which are fixed inside the radar for each transmission path and for all components of the return signal; then
/3/ determining a value of a phase shift which exists between the transmission radiations as produced by two of the transmission paths of the radar, called the transmission phase shift for these two transmission paths, based on a difference between the values of the transmission-reception phase shifts which were determined in step /2/ separately for each of the modulations of these two transmission paths.

Thus, the orthogonal modulations which are respectively assigned to the transmission paths of the radar make it possible to identify, in the return signal, the components which result one-to-one from the transmission radiations produced by the transmission paths. The transmission-reception phase shift which is determined in step /2/ for each transmission path then comprises two contributions: a controlled contribution for the purposes of beamforming, and an involuntary contribution which may vary depending on the transmission path concerned. Then, by comparing the transmission-reception phase shifts determined for two different transmission paths, and possibly subtracting the controlled contributions, the invention makes it possible to determine the differences between the unintentional contributions of phase shifts relative to the transmission paths taken in pairs. These differences are called transmission phase shifts.

The return signal can be caused from transmission radiation by any element of the scene located within the transmission field of the radar and which reflects the transmission radiations. It is therefore not necessary to use a reflector dedicated to a test sequence applied to the radar. It is also not necessary for particular usage conditions of the radar to be compatible with a test sequence. In other words, the method of the invention which groups steps /1/ to /3/ can be applied during any mission-related use of the radar. It can in particular be executed during a radar operating sequence intended to search for a target within an area of surveillance, once at least one echo is detected in response to each transmission beam. It can also be executed during any mission-related operating sequence of the radar, such as for example a sequence with the function of monitoring an area or a sequence intended to track the movement or evolution of an object.

Steps /1/ to /3/ may be repeated during several successive operating sequences of the radar, and the value of each transmission phase shift may be updated at the end of each repetition of step /3/.

By repeating steps /1/ to /3/, it is also possible to monitor the variations that may occur for each transmission phase shift. Such variations can indicate a deterioration—ageing or malfunction—of certain transmission components of the radar. On the basis of such value monitoring, it is then possible to schedule a radar maintenance operation when at least one of the transmission phase shifts exhibits too much variation. Optionally, a statistical analysis of an evolution of each transmission phase shift may be performed, based on the values determined for this transmission phase shift during the successive operating sequences of the radar. In this case, a radar maintenance operation may be scheduled if at least one result of the statistical analysis, for example an average value or a standard deviation, is greater than a predetermined deviation threshold.

Preferably, step /2/ may include, for each modulation, subtracting a controlled beamforming contribution that was used during the execution of step /1/, from the value of the corresponding transmission-reception phase shift. This controlled contribution relates to transmission and reception. The subtraction is performed before step /3/. In this manner, the values of the transmission-reception phase shifts and those of the transmission phase shifts which are obtained during repetitions of the sequence of steps /1/ to /3/ are consistent with each other, even if the direction of transmission of the radar has varied between some of these sequences. It is thus possible to calculate the average of the successive values of the transmission phase shift obtained for each of the paths, without requiring that the direction of transmission of the radar be constant. One is thus even better able to apply the method of the invention during a mission-related use of the radar, without disrupting the mission.

Possibly, the method of the invention may further comprise the following step:
/4/ adjusting, preferably numerically, a value of a phase offset of at least one of the two transmission paths, this phase offset value affecting the transmission radiation which is produced by the transmission path during at least one subsequent execution of step /1/, such that the value of the transmission phase shift which exists between the two transmission paths during the subsequent execution of step /1/ coincides with a beamforming target value, corresponding to the desired direction and shape of the transmission beam.

Thus, the transmission phase shifts that exist between at least some of the radar transmission paths can be compensated for by adjustable phase offsets available for these transmission paths. After such compensations for the transmission phase shifts, the radar transmission direction and the shape of the transmission beam more accurately correspond to the direction and shape desired, and controlled by the beamforming phase shifts.

The method of the invention may optionally be supplemented with a step of determining and/or compensating for differences in transmission amplitudes that may affect different transmission paths of the radar. For this purpose, for each modulation, in step /2/, a value of an amplitude quotient, between the component of the return signal which has been isolated in accordance with this modulation and the transmission radiation which has been produced and modulated in accordance with the same modulation, may be determined. Then, this amplitude quotient value may be stored for the modulation concerned, in particular to be used in an amplitude correction factor to be applied to the transmission path corresponding to this modulation. Optionally, for this transmission path, the transmission phase shift and the amplitude quotient between the component of the return signal and the transmission radiation may be compensated for simultaneously in step /4/.

To increase the reliability of the amplitude compensation of each transmission path, it is possible to calculate an average of the amplitude quotient for each modulation, from the amplitude quotient values determined beforehand for this modulation in each of several repetitions of the sequence of steps /1/ to /3/. Then, for each modulation, the average of the amplitude quotient may be used as an amplitude correction factor which is applied to the transmission path corresponding to this modulation, so that this amplitude correction factor is effective during at least one subsequent operating sequence of the radar.

Finally, in general for the invention, it is possible although optional to determine the value of the transmission-reception phase shift in step /2/ for each modulation only if at least one of the three following conditions is satisfied:
the component of the return signal which has been isolated in accordance with this modulation has an intensity greater than or equal to a predetermined intensity threshold;
the component of the return signal which has been isolated in accordance with this modulation has a frequency shift, in particular by Doppler effect, with respect to the transmission radiation which has been modulated in accordance with the same modulation, that is zero, or less than or equal to a predetermined frequency shift threshold, or greater than or equal to a predetermined frequency shift threshold, or within a predetermined frequency shift interval; and
the component of the return signal which has been isolated in accordance with this modulation has phase fluctuations, relative to the transmission radiation which has been modulated in accordance with the same modulation, that are less than or equal to a predetermined phase fluctuation threshold.

Furthermore, a second aspect of the invention proposes a radar which comprises:
at least two juxtaposed transmission paths, which are adapted to produce respective transmission radiations at each operating sequence of the radar;
at least one reception path, which is adapted to detect a return signal at each operating sequence of the radar;
modulators, arranged to modulate the transmission radiation that is produced by each transmission path in accordance with a modulation that is assigned to this transmission path, and that is orthogonal to the modulation that is assigned to each of the other transmission paths;
a filtering assembly, arranged to filter the return signal in accordance with each modulation, in order to isolate a component of the return signal that has this modulation; and
a calibration unit, adapted to implement a method according to the first aspect of the invention, including any of the abovementioned improvements and extensions.

### BRIEF DESCRIPTION OF THE DRAWINGS

Other features and advantages of the invention will be apparent from the following description of some non-limiting examples of its implementation, with reference to the accompanying drawings in which:

FIG. 1 is a perspective view of a MIMO radar antenna array to which the invention can be applied;

FIG. 2 is a diagram showing transmission and reception paths of a radar according to FIG. 1; and

FIG. 3 details operations performed within a calibration unit that is used to implement the invention.

### DESCRIPTION OF THE PREFERRED EMBODIMENTS

In addition, for clarity, radar components that are known to those skilled in the art and which are not directly concerned or modified by the invention are not described.

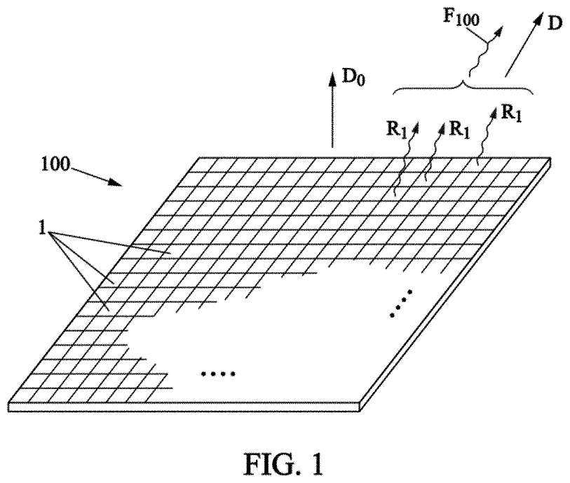

As shown in FIG. 1, a MIMO type radar has an antenna array 100. Such an antenna is composed of a set of radiating elements 1 which are juxtaposed in an array arrangement within a common plane, for example at the intersections of 16 rows and 16 columns, or 32 rows and 8 columns, although this is non-limiting. Do denotes the direction perpendicular to the plane of the antenna array 100. A radio signal to be transmitted by the antenna 100 is transmitted to each radiating element 1 with a phase shift which depends on the position of this radiating element in the array and on the desired inclination for the direction of transmission D with respect to direction Do. The grouping of the transmission radiations produced individually by all the radiating elements 1, denoted R₁, constitutes the transmission beam of the antenna 100, denoted F₁₀₀, and this beam has the transmission direction D which is determined by the relative phase shifts of the radiating elements 1. In a manner known to those skilled in the art, a similar principle is applied for the reception operation of the antenna array 100, to detect incident radiation in direction D. During transmission as well as during reception, the phase shifts that are applied to the radiating elements 1 also make it possible to adjust, in addition to the direction D, the shape of the transmission beam or the shape of the radiation beam which is detected.

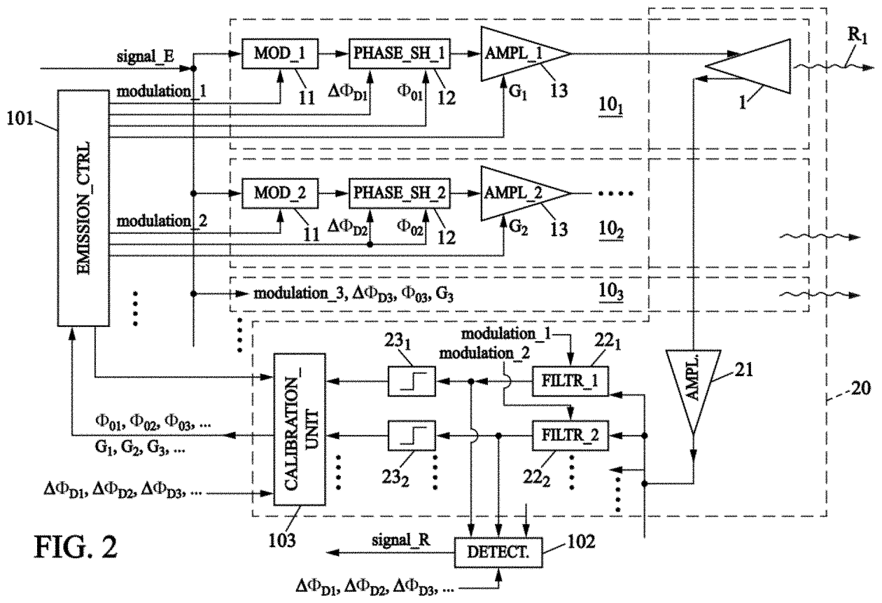

Within the radar, each radiating element 1 is part of a transmission path which is distinct from the path of each other radiating element. The references 10₁, 10₂, 10₃, . . . denote different transmission paths that are arranged in parallel. In addition, in the particular embodiment shown in FIG. 2, each radiating element 1 is also part of a reception path 20 which is distinct from the path of each other radiating element. For the sake of clarity in this figure, only transmission path 10₁ is completely detailed, and only one reception path 20 is shown, but it is understood that each radiating element 1 of the antenna array 100 is part of a distinct transmission path and a distinct reception path. However, in other possible embodiments, the receptor radiating elements of the reception paths may be components which are distinct from the radiating elements of the transmission paths. All the transmission paths 10₁, 10₂, 10₃, . . . are connected so that their inputs are supplied simultaneously and in parallel with a signal to be transmitted denoted signal_E. Moreover, all the reception paths 20 are connected to an input of a common detector 102, denoted DETECT., which outputs the signal received by the antenna 100, denoted signal_R.

In a known manner, each transmission path 10₁, 10₂, 10₃, . . . comprises, arranged serially: a modulator 11, denoted MOD_1 for transmission path 10₁, MOD_2 for transmission path 10₂, . . . , a phase shifter 12, denoted PHASE_SH_1 for transmission path 10₁, PHASE_SH_2 for transmission path 10₂, . . . an amplifier 13, denoted AMPL_1 for transmission path 10₁, AMPL_2 for transmission path 10₂, . . . , and the radiating element 1 of this transmission path. Furthermore, within each transmission path 10₁, 10₂, . . . , the phase shifter 12 is connected to an output of an emission controller 101, denoted EMISSION_CTRL, in order to receive a phase shift value to be applied to the transmission radiation R1 of this transmission path. This phase shift is denoted ΔΦ_{D1} for transmission path 10₁, ΔΦ_{D2} for transmission path 10₂, ΔΦ_{D3} for transmission path 10₃, etc. The set of phase shifts ΔΦ_{D1}, ΔΦ_{D2}, ΔΦ_{D3}, . . . which are thus transmitted to the phase shifters 12 of all the transmission paths 10₁, 10₂, 10₃, . . . make it possible to control the direction D and the shape of the beam F₁₀₀, as explained above. Finally, the modulator 11 of each transmission path 10₁, 10₂, . . . is also connected to the emission controller 101, to another output thereof, in order to receive the modulation to be applied to the transmission radiation R₁ of this transmission path. Thus, modulator MOD_1 receives modulation modulation_1, modulator MOD_2 receives modulation modulation_2, etc. Each modulation can be of any type, including CDMA, FDMA, TDMA, etc.

Each reception path 20 comprises, starting from the corresponding radiating element 1: an amplifier 21, a set of modulation filters 22₁, 22₂, . . . , denoted FILTR_1, FILTR_2, . . . and connected in parallel with each other within the reception path concerned, optionally one or more threshold filters 23₁, 23₂, . . . serially connected one-to-one with the modulation filters 22₁, 22₂, . . . , and a calibration unit 103 denoted CALIBRATION_UNIT. In addition, the outputs of the modulation filters 22₁, 22₂, . . . are connected to the detector 102 which also receives the phase shifts ΔΦ_{D1}, ΔΦ₂, . . . in order to select the reception direction of the antenna array 100. Each modulation filter 22₁, 22₂, . . . also receives one of the modulations that are applied to the modulators 11 in order to perform its filtering in accordance with this modulation. For example, filter 22₁ receives modulation modulation_1 which is implemented by modulator MOD_1, filter 22₂ receives modulation modulation_2 which is implemented by modulator MOD_2, and so on. Each of the modulations controlled by the emission controller 101 is thus transmitted to one of the modulation filters of each reception path 20. In this manner, the detector 102 and the calibration unit 103 receive all the components of the reception signal signal_R, separated from each other within each reception path 20. Possibly, the calibration unit 103 may be common to several or to all of the reception paths 20.

For clarity, one can initially assume that the modulations controlled by the emission controller 101 at the modulators 11 and at the filters 22₁, 22₂, . . . are all different and each is orthogonal to all the others.

According to the radar operation, the reception signal signal_R is produced by at least one reflection of the transmission beam F₁₀₀ on a scene element which is present at a distance from the antenna 100 in the transmission direction D corresponding to the phase shifts ΔΦ_{D1}, ΔΦ_{D2}, ΔΦ_{D3}, . . . . For this, the reception signal signal_R has been called a return signal in the general part of the present description. Optionally, several scene elements may be present simultaneously in the radar transmission direction, causing several echoes that are received by the radar with varying delays due to differences in the distance to these scene elements.

According to the invention, the calibration unit 103 is connected to an output of the emission controller 101 in order to receive a phase reference REF, or a time of a time reference, which is relative to the transmission of the signal signal_E. The calibration unit 103 is then adapted to determine, from the signals transmitted to it by all the filters 22₁, 22₂, . . . of a same one of the reception paths 20, a phase shift that exists between the transmission by one of the radiating elements 1 of the corresponding modulated radiation R₁, and the detection of the return signal component which has the same modulation. This phase shift was called the transmission-reception phase shift in the general part of the present description, and is denoted ΔΦ₀₁ for modulation modulation_1, ΔΦ₀₂ for modulation modulation_2, ΔΦ₀₃ for modulation modulation_3, etc. Such a transmission-reception phase shift thus exists separately for each transmission path 10₁, 10₂, 10₃, . . . , in association with the one of the filters 22₁, 22₂, . . . in the reception path 20 used which receives the same modulation as that transmission path. In addition, for a same one of the transmission paths 10₁, 10₂, 10₃, . . . , its transmission-reception phase shift ΔΦ₀₁, ΔΦ₀₂, ΔΦ₀₃, . . . can be determined as many times as the number of reception paths 20 which lead to the calibration unit 103. Such redundancy will not be mentioned again in the following.

The threshold filters 23₁, 23₂, . . . , which are optional, can contribute to the reliability of the values determined for the transmission-reception phase shifts Δω₀₁, ΔΦ₀₂, . . . by eliminating those of the filtered components of the return signal signal_R for which the intensities are too low, or those which have a frequency shift relative to the transmission signal signal_E, revealing that the scene element where the reflection originates is mobile. For this purpose, an intensity threshold and/or a lower bound for the frequency shift and/or an upper bound for the frequency shift may be applied within the threshold filters 23₁, 23₂, . . . . Similarly, a filtered component of the return signal can be rejected in determining a transmission-reception phase shift when it has phase fluctuations that are too large.

The calibration unit 103 can thus determine, for each pair of transmission paths, or for a restricted selection of these pairs, for example for the pair of transmission paths 10₁ and 10₂ or the pair of transmission paths 10₁ and 10₃, a difference between the two transmission-reception phase shifts which are individually related to each transmission path 10 of this pair. Then, by arbitrarily taking one of the transmission paths as a reference for all the other transmission paths, each of these differences is a transmission phase shift that is relative to the transmission path other than the reference transmission path. Thus, the calibration unit 103 determines a transmission phase shift value from the component of the return signal that comes from each of the modulation filters 22₁, 22₂, . . . . This value is the transmission phase shift of the one of the transmission paths which implements the same modulation as the modulation filter in question, ignoring the phase shift contribution of the filter itself. The difference operation between two transmission-reception phase shifts ensures that the transmission phase shift determined for each transmission path is independent of the distance, from the antenna 100, of the reflecting scene element that is the source of the return signal.

Thus, when transmission path 10₁ is taken as the reference, the transmission phase shift value of transmission path 10₂ is Φ₀₂=ΔΦ₀₂−ΔΦ₀₁, the transmission phase shift value of transmission path 10₃ is Φ₀₃=ΔΦ₀₃−ΔΦ₀₁, etc. As transmission path 10₁ is used as the reference: Φ₀₁=0.

These transmission phase shift values Φ₀₂, Φ₀₃, . . . , having a one-to-one relation to the transmission paths 10₂, 10₃, . . . can be transmitted by the calibration unit 103 to the emission controller 101, so that the latter can order the application of a correction equal to −Φ₀₂, −Φ₀₃, . . . to the beamforming phase shift ΔΦ_{D} that is transmitted to the corresponding transmission path. In this manner, the direction and shape of the beam F100 can be controlled more accurately. Additionally or alternatively, the values of the transmission phase shifts Φ₀₂, Φ₀₃, . . . can be transmitted to the detector 102 to be taken into account during reconstruction of the reception signal signal_R.

Within the calibration unit 103, the time or phase that corresponds to the detection of each component of the return signal can be determined in various ways. In particular, it can be determined as a clock value or a phase value which corresponds to a maximum instantaneous amplitude of this component of the return signal. However, other criteria can alternatively be applied for determining the time or phase that corresponds to the detection of each component of the return signal. Such other criteria may relate in particular to a maximum contrast existing between the return signal and a background noise detected between detection times which are different, or to a frequency or phase stability of each component of the return signal, which is maximal at the time selected as the reception time for this component, for example. To avoid introducing bias between the values determined for different transmission-reception phase shifts, these values are determined in relation to signal processing steps which are fixed within the calibration unit 103, and which are identical or equivalent for all filtered components of the return signal.

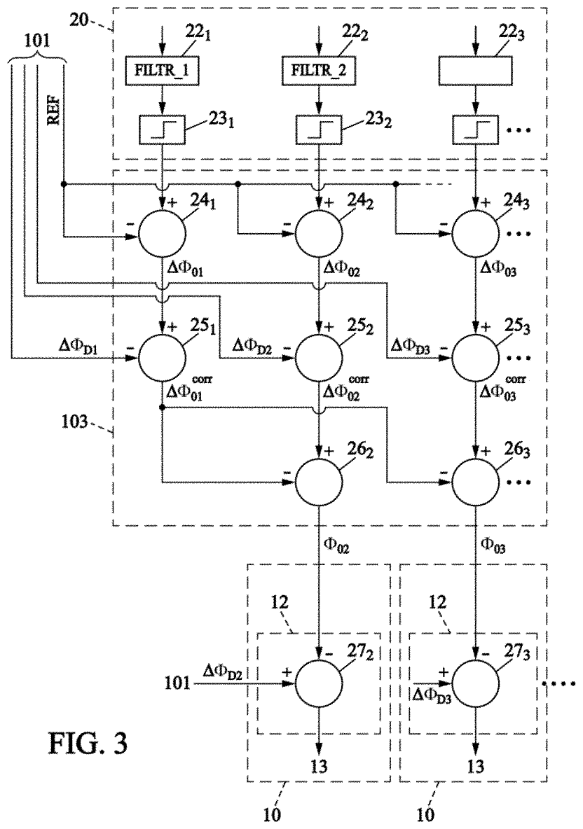

FIG. 3 illustrates the sequence of operations carried out according to the invention within the calibration unit 103 and the transmission phase shifters 12. The first step, symbolized by operators 24₁, 24₂, 24₃, . . . , consists of obtaining the phase difference between the signal component which is delivered by each of the modulation filters 22₁, 22₂, 22₃, . . . of a same reception path 20 on the one hand, and the phase reference REF which is delivered by the emission controller 101 on the other hand. The operators 24₁, 24₂, 24₃, . . . thus output the transmission-reception phase shifts ΔΦ₀₁, ΔΦ₀₂, ΔΦ₀₃, . . . in a one-to-one relation to the transmission paths 10₁, 10₂, 10₃, . . . . The second step, symbolized by operators 25₁, 25₂, 25₃, . . . , consists of subtracting for each transmission path 10₁, 10₂, 10₃, . . . , in other words for each modulation, the beamforming phase shift ΔΦ_{D1}, ΔΦ_{D2}, ΔΦ_{D3}, . . . which is applied by this transmission path. Transmission-reception phase shift values corrected for the intentional contributions of beamforming are thus obtained, denoted ΔΦ₀₁^{corr}, ΔΦ₀₂^{corr}, ΔΦ₀₃^{corr}, . . . . Finally, the third step, symbolized by operators 26₂, 26₃, . . . , consists of subtracting the corrected transmission-reception phase shift value which has been obtained for one of the transmission paths used as a reference, for example the value ΔΦ₀₁^{corr} delivered by operator 25₁, from each of the corrected transmission-reception phase shift values ΔΦ₀₂^{corr}, ΔΦ₀₃^{corr}, . . . that have been obtained for the other transmission paths 10₂, 10₃, . . . . Thus, the transmission phase shift values Φ₀₂, Φ₀₃, . . . relating to each of these other transmission paths 10₂, 10₃, . . . are obtained. Each operator 27₂, 27₃, . . . symbolically represents the compensation of the transmission phase shifts Φ₀₂, Φ₀₃, . . . that can be performed for each of these latter transmission paths 10₂, 10₃, . . . within the emission controller 101 or separately in each transmission phase shifter 12, for the subsequent operating sequences of the radar. For this, the transmission phase shift value Φ₀₂, Φ₀₃, . . . which has been determined for each transmission path 10₂, 10₃, . . . can be subtracted from the subsequent values of the beamforming phase shift ΔΦ_{D2}, ΔΦ_{D3}, . . . which are applied by the phase shifter 12 of this transmission path.

As already mentioned, the method just described does not require that a particular operating sequence be implemented for the radar, nor that particular environmental conditions be produced. In other words, it can be applied during productive operating sequences, also referred to as mission-related operating sequences of the radar. It is then possible to collect, with each new operating sequence of the radar, a new value for the transmission phase shift of each transmission path. The value of the transmission phase shift which is transmitted to the phase shifter 12 of each transmission path 10 for compensation can be updated after each new operating sequence of the radar, or after a predetermined number of operating sequences. It is also possible to monitor over time a temporal evolution in the values successively obtained for a same transmission phase shift, which can reveal a progressive aging or a malfunction of the corresponding transmission path. The use of a deviation threshold for each transmission phase shift, relative to an initial value obtained at a reference date for this transmission phase shift, or the use of a standard deviation threshold for the series of values obtained for each transmission phase shift, can allow triggering a maintenance operation for the radar.

Additionally or alternatively, the transmission phase shift value that is transmitted by the calibration unit 103 to the emission controller 101 may be an average value of a determined number of transmission phase shift values that have been successively obtained for a same transmission path. This average value is then subtracted by the emission controller 101 or phase shifter 12 which is applied to the transmission path concerned 10, in order to adjust the transmission direction D and the shape of the beam F100. Each average value can be calculated on a rolling set of values that have been successively obtained, or else calculated on disjoint sets of values successively obtained.

However, the method of the invention can be implemented during dedicated operating sequences, for example sequences dedicated to the calibration of transmission paths. Then a specific reflector can be used, arranged in front of the antenna array 100, and which can make it possible to improve the signal-to-noise ratio that is in effect when the return signal is detected for the calibration sequences. Alternatively, the method of the invention can also be implemented by electrically connecting the outputs of the phase shifters 12 of the transmission paths 10 directly to the inputs of all the modulation filters 22₁, 22₂, . . . of the reception path 20 used to implement the invention.

In addition to the transmission phase shift which can unintentionally affect each transmission path 10 independently of the other transmission paths, and which the invention can compensate for as described above, it is possible for the transmission paths 10 to produce transmission radiations R₁ of intensities that differ from one transmission path to another. Such variations in transmission intensity, between two different transmission paths within the radar, may also be unintentional and due to manufacturing variability in the components that form part of the transmission pathways, or due to differing aging rates of these components between the different transmission paths. The calibration unit 103 can then, optionally, determine the amplitude of the component of the return signal which is filtered by each of the modulation filters 22₁, 22₂, . . . of a same reception path 20. Next it calculates the quotient between an amplitude of the radiation R₁ whose modulation is that of the component concerned of the return signal, and the amplitude of that component of the return signal. This quotient is denoted G₁ for modulation modulation_1, G₂ for modulation modulation_2, G₃ for modulation modulation_3, . . . , and can be transmitted via the emission controller 101 to the amplifier 13 of the one of the transmission paths 10₁, 10₂, 10₃, . . . which has the modulation concerned. Compensation for the amplitude error is thus obtained for this transmission path. This amplitude compensation method can be performed in parallel for all modulations.

Similarly to each transmission phase shift value, an average value can be calculated from a plurality of values that have been obtained for the amplitude quotient of a same transmission path during successive radar operating sequences. This can also involve moving averages which are calculated on a constant number of successively obtained values, or averages calculated on disjoint sets of successively obtained values. Then these average values can be transmitted to the amplifier 13 of the transmission path concerned as an amplitude correction factor for the transmission radiation R₁ produced by this transmission path. In a known manner, for the function of controlling the shape of the transmission beam F100, the amplifiers 13 of all the transmission paths do not nominally have amplification factors that are identical. For each transmission path, the amplitude quotient is used to correct the nominal amplification factor for the transmission path considered.

It is understood that the invention may be reproduced while modifying secondary aspects thereof in comparison to the embodiments detailed above. In particular, the antenna array may have any dimensions in terms of numbers of rows and columns. In addition, the radar may be of the monostatic or bistatic type, in other words the reception path which is used to implement the invention may be located at the same place as the transmission paths or may be located at a place that is remote from them.

Moreover, it is possible to apply the invention by grouping the transmission paths in disjoint subsets of several paths. Such a new embodiment can be deduced from the detailed description that has been provided, by replacing each individual transmission path with a subset of several transmission paths. The same modulation is then common to all the transmission paths of the same subset, and orthogonal to the modulation of each other subset.

1. Method for determining at least one transmission phase shift of a radar which comprises at least two juxtaposed transmission paths (10₁, 10₂, 10₃) and at least one reception path (20), said radar being arranged so that each transmission path produces a transmission radiation (R₁) modulated in accordance with a modulation that is assigned to said transmission path and that is orthogonal to the modulation that is assigned to each of the other transmission paths, and said radar being arranged so that, when the reception path detects a return signal, said return signal is filtered in accordance with each modulation in order to isolate a component of the return signal which has said modulation,
the method comprising the following steps:
/1/ activating the transmission paths (10₁, 10₂, 10₃) to produce the modulated transmission radiations (R₁) and activating the reception path (20) to detect the return signal, then filtering said return signal in accordance with each modulation;
/2/ separately for each modulation: determining a value of a phase shift between transmission and reception, called the transmission-reception phase shift (ΔΦ₀₁, ΔΦ₀₂, ΔΦ₀₃) for said modulation, which exists between the transmission radiation (R₁) produced and modulated in accordance with said modulation and the component of the return signal which has been isolated in accordance with the same modulation, said transmission-reception phase shift being determined for signal passage points which are fixed inside the radar for each transmission path (10₁, 10₂, 10₃) and for all components of the return signal; then
/3/ determining a value of a phase shift which exists between the transmission radiations as produced by two of the transmission paths (10₁, 10₂, 10₃) of the radar, called the transmission phase shift (Φ₀₂, Φ₀₃) for said two transmission paths, based on a difference between the values of the transmission-reception phase shifts (ΔΦ₀₁, ΔΦ₀₂, ΔΦ₀₃) which were determined in step /2/ separately for each of the modulations of said two transmission paths.

2. Method according to claim 1, further comprising the step of:
/4/ adjusting, preferably numerically, a value of a phase offset of at least one of the two transmission paths (10₁, 10₂, 10₃), said phase offset value affecting the transmission radiation (R₁) which is produced by said transmission path during at least one subsequent execution of step /1/, such that the value of the transmission phase shift (Φ₀₂, Φ₀₃) which exists between the two transmission paths during said subsequent execution of step /1/ coincides with a beamforming target value, corresponding to a desired direction and shape of the transmission beam.

3. Method according to claim 1, executed during a mission-related use of the radar, said mission-related use comprising an operating sequence of the radar intended to search for a target within an area of surveillance, or to track a movement or evolution of a target.

4. Method according to claim 1, wherein steps /1/ to /3/ are repeated during several successive operating sequences of the radar, and the value of each transmission phase shift (Φ₀₂, Φ₀₃) is updated at the end of each repetition of step /3/.

5. Method according to claim 4, further comprising performing of a statistical analysis of an evolution of each transmission phase shift (Φ₀₂, Φ₀₃), based on the values determined for said transmission phase shift during the successive operating sequences of the radar, and wherein a radar maintenance operation is scheduled if at least one result of the statistical analysis is greater than a predetermined deviation threshold.

6. Method according to claim 1, wherein step /2/ includes, for each modulation, subtracting a controlled beamforming contribution (ΔΦ_{D1}, ΔΦ_{D2}, ΔΦ_{D3}) that was used during execution of step /1/, from the value of the transmission-reception phase shift (ΔΦ₀₁, ΔΦ₀₂, ΔΦ₀₃).

7. Method according to claim 1, wherein for each modulation, in step /2/, a value of an amplitude quotient (G₁, G₂, G₃), between the component of the return signal which has been isolated in accordance with said modulation and the transmission radiation (R₁) which has been produced and modulated in accordance with the same modulation, is also determined.

8. Method according to claim 7, wherein an average of the amplitude quotient (G₁, G₂, G₃) is calculated for each modulation, from the amplitude quotient values determined for said modulation in each of several repetitions of the sequence of steps /1/ to /3/,
and wherein, for each modulation, the average of the amplitude quotient (G₁, G₂, G₃) is used in an amplitude correction factor which is applied to the transmission path (10₁, 10₂, 10₃) corresponding to said modulation, so that said amplitude correction factor is effective during at least one subsequent operating sequence of the radar.

9. Method according to claim 1, wherein the value of the transmission-reception phase shift (ΔΦ₀₁, ΔΦ₀₂, ΔΦ₀₃) is determined in step /2/ for each modulation only if at least one of the following three conditions is satisfied:
the component of the return signal which has been isolated in accordance with said modulation has an intensity greater than or equal to a predetermined intensity threshold;
the component of the return signal which has been isolated in accordance with said modulation has a frequency shift, with respect to the transmission radiation (R₁) which has been modulated in accordance with said modulation, that is zero, or less than or equal to a predetermined frequency shift threshold, or greater than or equal to a predetermined frequency shift threshold, or within a predetermined frequency shift interval; and
the component of the return signal which has been isolated in accordance with said modulation has phase fluctuations, relative to the transmission radiation (R₁) which has been modulated in accordance with said modulation, that are less than or equal to a predetermined phase fluctuation threshold.

10. Radar comprising:
at least two juxtaposed transmission paths (10₁, 10₂, 10₃), adapted to produce respective transmission radiations (R₁) at each operating sequence of the radar;
at least one reception path (20), adapted to detect a return signal at each operating sequence of the radar;
modulators (11), arranged to modulate the transmission radiation (R₁) that is produced by each transmission path (10₁, 10₂, 10₃) in accordance with a modulation that is assigned to said transmission path, and that is orthogonal to the modulation that is assigned to each of the other transmission paths;
a filtering assembly (22₁, 22₂, . . . ), arranged to filter the return signal in accordance with each modulation, in order to isolate a component of the return signal that has said modulation; and
a calibration unit (103),
wherein the calibration unit (103) is adapted to implement a method which is in accordance with claim 1.

11. Method according to claim 2, executed during a mission-related use of the radar, said mission-related use comprising an operating sequence of the radar intended to search for a target within an area of surveillance, or to track a movement or evolution of a target.

12. Method according to claim 2, wherein steps /1/ to /3/ are repeated during several successive operating sequences of the radar, and the value of each transmission phase shift (Φ₀₂, Φ₀₃) is updated at the end of each repetition of step /3/.

13. Method according to claim 3, wherein steps /1/ to /3/ are repeated during several successive operating sequences of the radar, and the value of each transmission phase shift (Φ₀₂, Φ₀₃) is updated at the end of each repetition of step /3/.

14. Method according to claim 2, wherein step /2/ includes, for each modulation, subtracting a controlled beamforming contribution (ΔΦ_{D1}, ΔΦ_{D2}, ΔΦ_{D3}) that was used during execution of step /1/, from the value of the transmission-reception phase shift (ΔΦ₀₁, ΔΦ₀₂, ΔΦ₀₃).

15. Method according to claim 3, wherein step /2/ includes, for each modulation, subtracting a controlled beamforming contribution (ΔΦ_{D1}, ΔΦ_{D2}, ΔΦ_{D3}) that was used during execution of step /1/, from the value of the transmission-reception phase shift (ΔΦ₀₁, ΔΦ₀₂, ΔΦ₀₃).

16. Method according to claim 4, wherein step /2/ includes, for each modulation, subtracting a controlled beamforming contribution (ΔΦ_{D1}, ΔΦ_{D2}, ΔΦ_{D3}) that was used during execution of step /1/, from the value of the transmission-reception phase shift (ΔΦ₀₁, ΔΦ₀₂, ΔΦ₀₃).

17. Method according to claim 5, wherein step /2/ includes, for each modulation, subtracting a controlled beamforming contribution (ΔΦ_{D1}, ΔΦ_{D2}, ΔΦ_{D3}) that was used during execution of step /1/, from the value of the transmission-reception phase shift (ΔΦ₀₁, ΔΦ₀₂, ΔΦ₀₃).

18. Method according to claim 2, wherein for each modulation, in step /2/, a value of an amplitude quotient (G₁, G₂, G₃), between the component of the return signal which has been isolated in accordance with said modulation and the transmission radiation (R₁) which has been produced and modulated in accordance with the same modulation, is also determined.

19. Method according to claim 3, wherein for each modulation, in step /2/, a value of an amplitude quotient (G₁, G₂, G₃), between the component of the return signal which has been isolated in accordance with said modulation and the transmission radiation (R₁) which has been produced and modulated in accordance with the same modulation, is also determined.

20. Method according to claim 4, wherein for each modulation, in step /2/, a value of an amplitude quotient (G₁, G₂, G₃), between the component of the return signal which has been isolated in accordance with said modulation and the transmission radiation (R₁) which has been produced and modulated in accordance with the same modulation, is also determined.
